(19) United States
(12) Patent Application Publication
(10) Pub. No.: US 2013/0040508 A1
(43) Pub. Date: Feb. 14, 2013

(54) CURVED SPRING BEAM HAVING COINED INDENTATIONS

(71) Applicant: James R. Martellotti, Tustin, CA (US)

(72) Inventor: James R. Martellotti, Tustin, CA (US)

(21) Appl. No.: 13/571,913

(22) Filed: Aug. 10, 2012

Related U.S. Application Data
(60) Provisional application No. 61/521,974, filed on Aug. 10, 2011.

(51) Int. Cl. H01R 4/48

(52) U.S. Cl. 439/861

(57) ABSTRACT

An electrical socket design for a pin and socket connector is provided that increases the spring rate of a tine of the socket by displacing material away from a neutral plane of the tine, which increases the tine's moment of inertia. Increasing the moment of inertia increases the spring rate and thereby increases the contact force of the tine on the pin. The material can be readily displaced by a coining process, which can be implemented in a manufacturing process with minimal changes and can also readily accommodate design adjustments.

### CROSS REFERENCE TO RELATED APPLICATIONS

This application claims the benefit under 35 U.S.C. §119(e) of U.S. Provisional Patent Application No. 61/521,974, filed on Aug. 10, 2011 the disclosure of which is incorporated by reference herein.

### STATEMENT REGARDING FEDERALLY SPONSORED RESEARCH OR DEVELOPMENT

N/A

### BACKGROUND OF THE INVENTION

One type of electrical connector includes a socket having one or more tines formed from a springy material. Each tine extends as a curved cantilever beam from a base member or sleeve and acts as a spring to make electrical contact with a pin.

### SUMMARY OF THE INVENTION

A cantilever beam designed to act as a spring has certain properties based on the shape of the beam, the thickness and length of the beam, and any tapers or changes that may be present along the beam. In some cases, such as in electrical connectors of the round pin and socket design, there may be a desire to increase the force exerted on the pin by the cantilever beam with no changes to the material or the beam's basic geometry. For example, electrical connector designs can be pressed for real estate, due to space constraints of the application. There may be no realistic method available to increase the contact force while maintaining the connector size. It may not be possible to add material to make the tine wider or thicker. It also may not be possible to make substantial changes to the manufacturing process.

Accordingly, a socket design is provided that increases the spring rate of the cantilever beam design of a tine by displacing material away from a neutral plane of the beam, which increases the beam's moment of inertia. Increasing the moment of inertia increases the spring rate and thereby increases the contact force of the tine on the pin. The material can be readily displaced by a coining process, which can be implemented in a manufacturing process with minimal changes and can also readily accommodate design adjustments.

### DESCRIPTION OF THE DRAWINGS

The invention will be more fully understood from the following detailed description taken in conjunction with the accompanying drawings in which:

FIG. 1 is an isometric view of one embodiment of an electrical connector employing a socket with coined indentations to increase a moment of inertia according to the present invention;

FIG. 2A illustrates a curved cantilever beam cross section without coining;

FIGS. 2B and 2C illustrate a curved cantilever beam cross section with coining;

FIG. 2D illustrates a non-curved cantilever beam cross section with coining;

FIG. 3A illustrates an example of a calculated moment of inertia of a cross section without coining;

FIG. 3B illustrates an example of a calculated moment of inertia of a cross section with coining, showing an increase compared to FIG. 3A;

FIG. 4 is an isometric view of one embodiment of indentations in a tine;

FIG. 5 is a further isometric view of the embodiment of FIG. 4;

FIG. 6 illustrates various steps in a process for manufacturing a socket having coined indentations according to the present invention; and

FIG. 7 is an isometric view of a further embodiment of a socket according to the present invention.

### DETAILED DESCRIPTION OF THE INVENTION

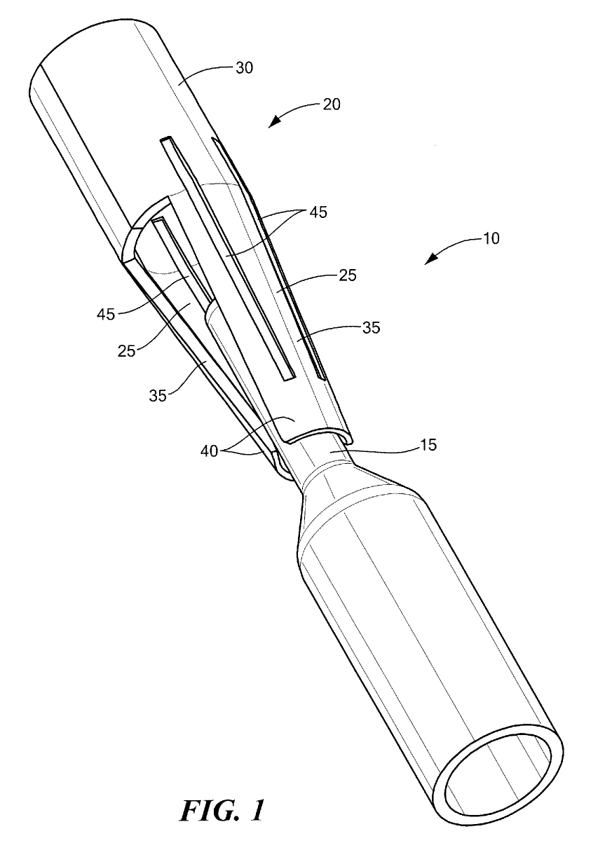

Referring to FIG. 1, one embodiment of an electrical connector 10 according to the present invention includes a pin 15 and a socket 20. The socket includes one or more tines 25 that extend from a base member 30 in the form of a cantilever beam 35 having a curved cross section. The pin makes electrical contact with the tines 25 at their tips 40. (Two tines are shown, although any other number of tines, including a single tine, can be used.) The tines are formed of a springy metal material and have a spring rate or spring constant that biases the tines into contact with the pin. The area or second moment of inertia of the cross section of the beam 35 is increased over that of prior art tines to thereby increase the spring rate or spring constant of the tine, which increases the contact force with the pin 15. (The area or second moment of inertia may be referred to as moment of inertia or moment herein.) The moment of inertia is increased by displacing material away from a neutral point or plane that runs through the cross section of the beam. The material is displaced by forming indentations 45 into the tines, suitably, with a coining process, as described further below.

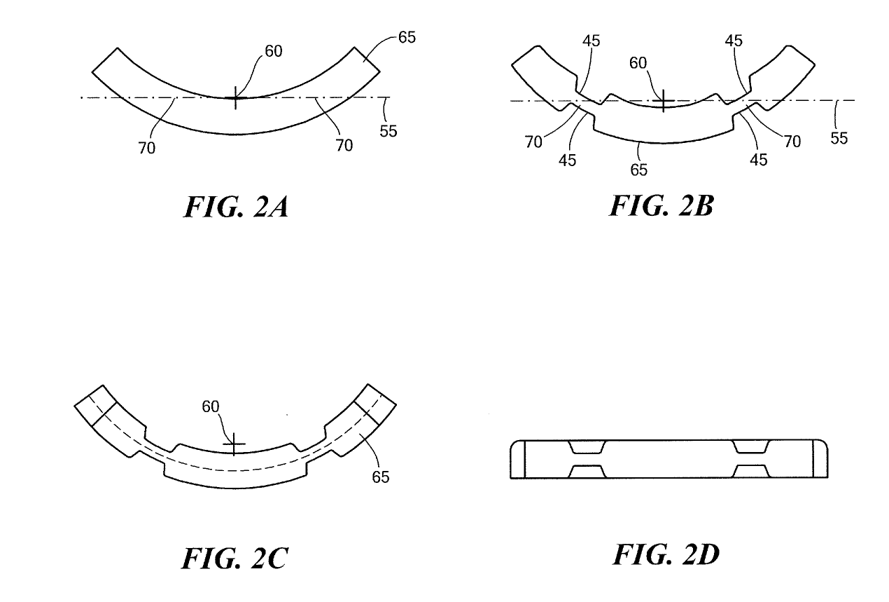

More particularly, a cantilever beam designed to act as a spring has certain properties based on the shape of the beam, the thickness and length of the beam, and any tapers or changes that may be present along the beam. One of the shape or geometric properties that affects the spring properties is the area or second moment of inertia. Changes to the cross sectional width, thickness, or radius of curvature of the beam can alter the moment of inertia. For the case of the electrical socket as described herein, however, the beam's geometric properties of radius of curvature, thickness and width (defined before curvature during manufacture) are all given. Nevertheless, the spring force can still be increased by displacing material away from the neutral plane 55, which effectively increases the width of the curved shape. (See FIGS. 2A-2D.) The neutral plane 55 is a plane that runs through the calculated centroid 60 of the cross sectional shape 65 and is perpendicular to the direction of deflection of the spring beam. The calculation for the moment of inertia of a spring beam is a function of the square of the distance of each point of area from the neutral plane. Thus, the area moment of inertia can be increased by moving material away from the neutral plane and towards the furthest points from the neutral plane.

The moment of inertia of any cross section of a beam can be readily calculated by one of skill in the art, and this calculation is typically a standard operation on any CAD system. Accordingly, the calculations are not repeated herein. Similarly, CAD systems can typically determine other geometric properties of a cross sectional shape, such as the area and the location of the centroid, the calculations for which are known by one of skill in the art and are not repeated herein.

FIGS. 2A and 2B illustrate a curved beam in cross section (having the shape 65 of a smile), which is the cross section used to calculate the moment. The further the material is from the neutral plane 55, the greater its contribution to increasing the moment, whereas material in the neutral plane 55 contributes little to the moment. The line through the cross section at the neutral or central plane can be used to best locate where the neutral plane crosses the curved cross section of the beam. At those two regions 70, material is displaced, for example, by coining, to move the material away from the neutral plane. The coining process does not remove material but only causes it to be displaced. The displaced material is moved away from the coined indentation 45 and therefore away from the neutral plane 55, which causes more material to be further from the neutral plane. This in turn causes the moment of inertia to increase. The cross sectional area of the beam remains unchanged, which can be determined by one of skill in the art and by any typical CAD system.

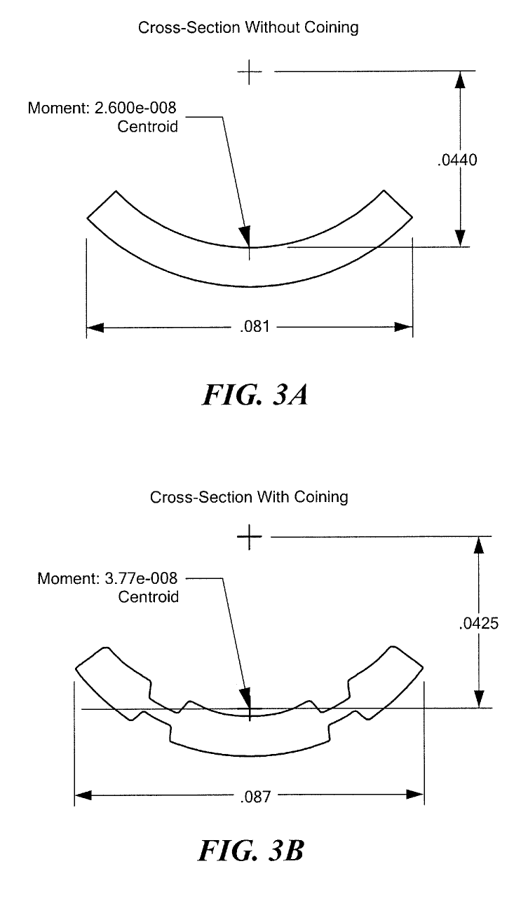

An example is illustrated in FIGS. 3A and 3B. The tine is in the form of a simple curved cantilever beam such as might be used in the socket side of a pin and socket connector. A typical cross section without coining is illustrated along with a line through its centroid or neutral plane (FIG. 3A). Also illustrated is the same beam with coining in the area of its neutral plane (FIG. 3B). In both illustrations the cross sectional areas are identical, which can be confirmed by a CAD system. The moment increases from 2.600×10⁻⁸ in⁴ without coining to 3.77×10⁻⁸ in⁴ with coining. The width dimension from edge to edge of the beam parallel to the neutral plane increases from 0.081 in. without coining to 0.087 in. with coining. The location of the centroid moves upwardly, from 0.0440 in. from the center of radius without coining to 0.0425 in. from the center of radius with coining. Although the areas are identical, and the only difference is the coined indentations displacing some material, the moment of the coined cross section is about 45% greater than the moment of the cross section without coining.

With the present invention, the spring rate can be changed simply by adjusting the depth of the coining without changing the material, the radius of curvature or other formed dimensions of the tine. The moment and thus the spring rate of the tine can be increased without adding to the envelope of the beam as defined by its inner and outer radius. The coined indentation is illustrated as being generally rectangular in cross section; however, other coining configurations can be employed. Beams with other shapes, curvatures, etc. will have different moments. Note that if the beam were flat and not curved, the coining would only displace material along the neutral plane and not away from it as with the curved cross section beam and it would show no change to the moment in that plane, (but would increase the moment of inertia about a plane perpendicular to the long axis of the cross section). See FIGS. 2C and 2D.

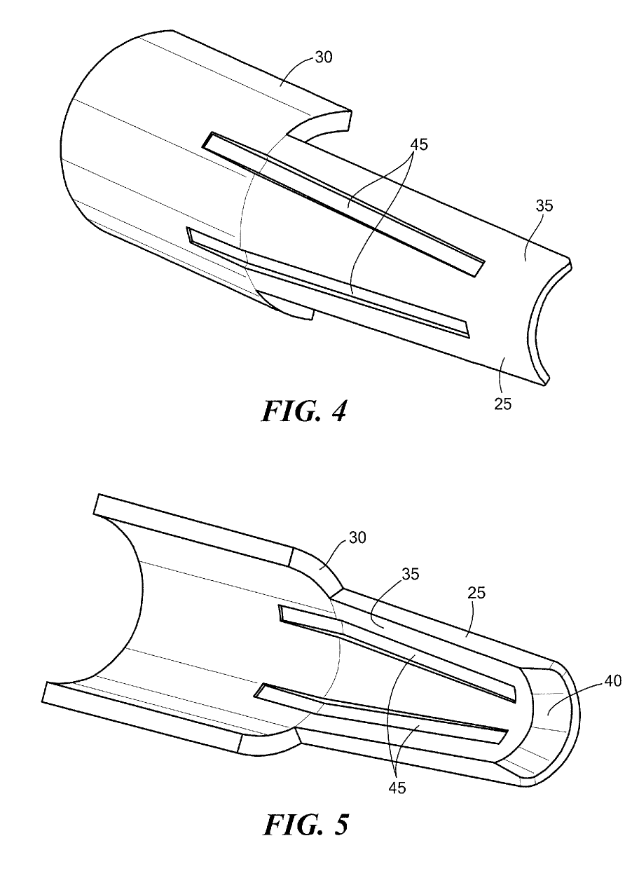

In one embodiment, illustrated in FIGS. 4 and 5, the indentations 45 generally extend linearly along the length of the tine from a position near a root end, which may be within the base member, to a position near the tip end. The indentation typically does not extend completely to the end, because the end of the tine is the point that makes electrical contact with the pin. The indentations are formed symmetrically on both sides of the centroid where the neutral plane crosses the beam. Indentations can be formed in both upper and lower surfaces of the tine. Alternatively, indentations can be formed in one surface only. The desired length, width, and depth of the indentation as well as the number and location of indentations can be readily determined by most CAD systems to achieve a desired spring rate.

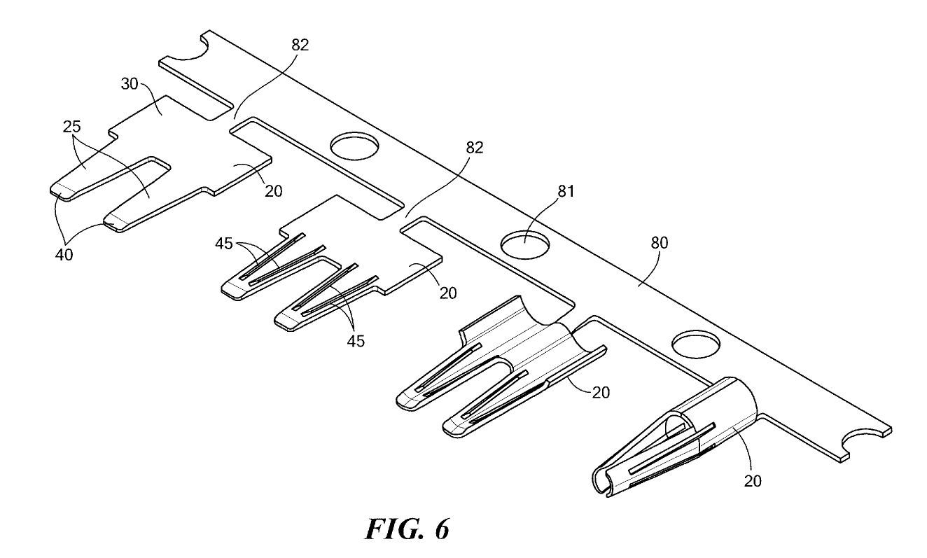

FIG. 6 illustrates various steps in a manufacturing process for the socket. The manufacturing process begins by providing a sheet of a suitable metal. The sheet is cut or stamped to provide a strip 80 with multiple sockets 20 attached to the strip. The strip typically includes pilot holes 81 for moving the strip through the fabrication process. The tips 40 are formed such as by stamping. The indentations 45 are coined into one or both surfaces of the tines 25. The tines 25 are curved to impart the desired curvature to the cantilever beam 35. The base member 30 is bent to form a sleeve of cylindrical shape and to bring the curved tines into opposition. The sockets are separated from the strip 80 at junctions 82, which are generally flush with the socket. The tooling used in the process typically can be configured and/or programmed to achieve the design determined with the use of a CAD system.

The present connector socket including tines with indentations of displaced material also provides advantages to the manufacturing process. Such connector sockets are typically manufactured by stamping. Even if additional space were available to utilize a tine with a wider width, cutting a wider tine would require a change to one or more cutting stations in the tool. Cutting a wider width may also require that the cutting punches be narrower than reasonable for the material being cut. With the present socket, the change in the manufacturing process occurs only at the coining station. The coining step can be altered simply by shortening or lengthening the coining punch. The depth of the coining can also be adjustable, typically in seconds just by the turn of a screw. This type of force adjustability is not possible when it involves changing the physical dimension of the tine that is created by the cutting stations.

The socket is generally formed as an integral piece from a single sheet of material. Any suitable material can be used to achieve the desired springiness and electrical conductivity. Typically, metals having good electrical conductivity are used, such as a copper alloy. However, electrically conductive materials can be plated or otherwise coated onto to the tips of the tines, such as nickel, tin, or gold for corrosion resistance.

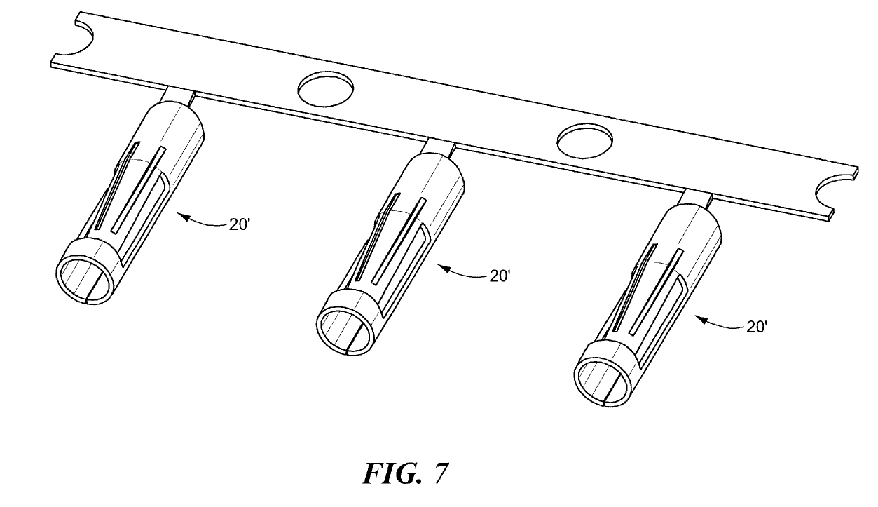

It will be appreciated that the concept of increasing the moment of inertia of a tine or spring beam can be applied to other configurations. For example, FIG. 7 illustrates a further embodiment of an electrical connector socket 20′ in which a tine is formed in a mid section of a socket. The concept can be applied to beams other than cantilever beams In another alternative, a tine can be attached at both ends within a socket, with the contact point somewhere between the two ends of the tine.

The invention is not to be limited by what has been particularly shown and described, except as indicated by the appended claims.

What is claimed is:

1. An electrical socket for a pin and socket electrical connection, the socket comprising:
a base member and a tine extending as a beam from the base member to a contact end, the tine formed from a springy material and having a spring constant to bias the contact end of the tine into contact with a pin,
the beam extending along a longitudinal axis and having a curved cross section, the curved cross section having a centroid and a neutral plane extending through the centroid perpendicular to the longitudinal axis, and
the beam including indentations of displaced material, the displaced material displaced from the indentations in a direction away from the neutral plane to increase a moment of inertia of the cross section of the beam compared with a beam having a same cross sectional area and radius of curvature without indentations.

2. The electrical socket of claim 1, wherein the indentations are symmetrically located on opposite sides of the longitudinal axis.

3. The electrical socket of claim 1, wherein the indentations comprise a pair of indentations on a concave surface of the beam.

4. The electrical socket of claim 1, wherein the indentations comprise a pair of indentations on a convex surface of the beam.

5. The electrical socket of claim 1, wherein the indentations are formed on concave and convex surfaces of the beam.

6. The electrical socket of claim 1, wherein the indentations extend linearly along at least a portion of a length of the beam.

7. The electrical socket of claim 6, wherein the indentations extend to a point spaced from a tip of the beam.

8. The electrical socket of claim 6, wherein the indentations extend from a point located within the base member.

9. The electrical socket of claim 1, wherein the beam comprises a cantilever beam having one end attached to the base member.

10. The electrical socket of claim 1, wherein the tine is formed of an electrically conductive metal material.

11. The electrical socket of claim 1, further comprising at least one further tine extending as a beam from the base member to a contact end, the tine including indentations of displaced material, the displaced material displaced from the indentations in a direction away from a neutral plane of a cross section of the beam to increase a moment of inertia of the cross section of the beam compared with a beam having a same cross sectional area and radius of curvature without indentations.
